(19) United States
(12) Patent Application Publication
(10) Pub. No.: US 2009/0227368 A1
(43) Pub. Date: Sep. 10, 2009

(54) DISPLAY OF NOTATIONAL OBJECT IN AN INTERACTIVE ONLINE ENVIRONMENT

(75) Inventor: Patrick J. Wyatt, Bellevue, WA (US)

Correspondence Address: LARSON NEWMAN ABEL & POLANSKY, LLP, 5914 WEST COURTYARD DRIVE, SUITE 200, AUSTIN, TX, 78730, US

(73) Assignee: ARENANET, INC., Bellevue, WA (US)

(21) Appl. No.: 12/044,689

(22) Filed: Mar. 7, 2008

(51) Int. Cl. A63F 13/00

(52) U.S. Cl. 463/31; 463/42

(57) ABSTRACT

A method of displaying notes in an interactive game environment includes receiving information indicative of the note content, and displaying the note as a three-dimensional object in the game environment. The displayed note can be configured so that it is only visible in designated contexts, or to designated players or designated groups.

### FIELD OF THE DISCLOSURE

The present disclosure relates to interactive online environments, and more particularly to online multiplayer games.

### BACKGROUND

Interactive online environments, such as multiplayer online games, have become increasingly popular in recent years. In such environments, an avatar, such as a game character, typically represents a participant in the online environment. The participant interacts with the online environment by manipulating the avatar. For example, by moving the avatar through the online environment, the participant can explore the environment. In addition, the participant can interact with other participants of the online environment. Typically, this is done by interaction of the participants avatars via a set of predetermined message options. However, this interaction can be difficult, as the participant must find the avatar of the desired participant, and the limited set of message options limit the subjects of interaction between the avatars. Accordingly, an improved method of communication in an online environment would be useful.

### BRIEF DESCRIPTION OF THE DRAWINGS

The present disclosure may be better understood, and its numerous features and advantages made apparent to those skilled in the art by referencing the accompanying drawings.

FIG. 1 illustrates a block diagram of a communication system 100 in accordance with one embodiment of the present disclosure.

FIG. 2 illustrates a diagram of a graphical user interface in accordance with an embodiment of the present disclosure.

FIG. 3 is a flow diagram of a method of displaying a note object in accordance with one embodiment of the present disclosure.

FIG. 4 is a flow diagram of a method of creating a note object in accordance with one embodiment of the present disclosure.

FIG. 5 is a block diagram of an embodiment of a computer device in accordance with one embodiment of the present disclosure.

The use of the same reference symbols in different drawings indicates similar or identical items.

### DETAILED DESCRIPTION

A method of displaying notes in an interactive game environment includes receiving information indicative of the note content, and displaying the note as a three-dimensional object in the game environment. The displayed note can be configured so that it is only visible in designated contexts, or to designated players or designated groups.

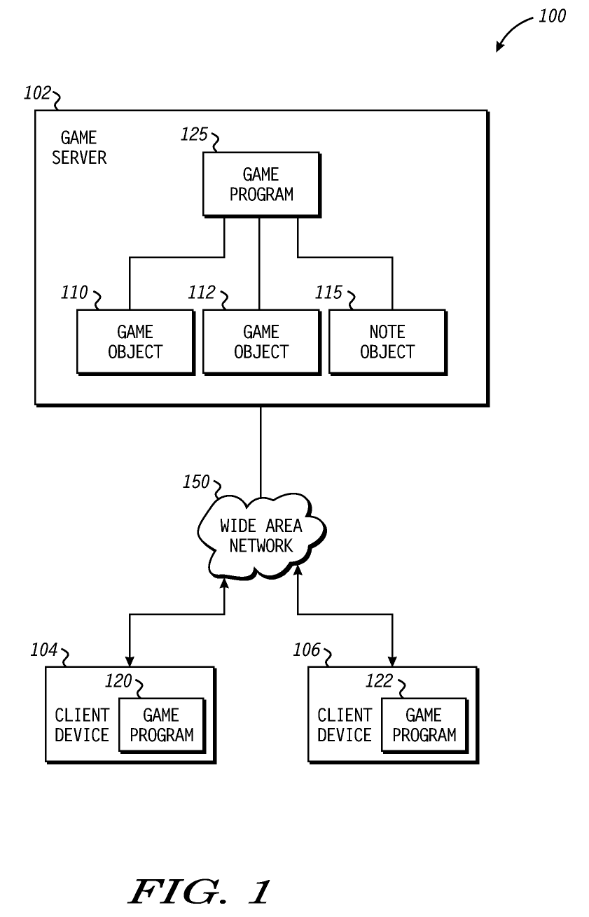

FIG. 1 illustrates a block diagram of a communication system 100 in accordance with one embodiment of the present disclosure. The communication system 100 includes a wide area network 150 connected to a game server 102 and client devices 104 and 106. The wide area network 150 can be a packet switched network that provides a physical communication layer to route packets between the game server 102 and the client device 104 and 106. In an embodiment, the wide area network 150 is the Internet.

The game server 102 is a computer device, such as a computer configured as a server device, which executes a game program 125. The game program 125 interacts with a game program 120 and a game program 122 at the client devices 104 and 106, respectively, to create an online gaming environment. To illustrate, the game program 125 includes a number of game objects, including game objects 110 and 112. The game objects 110 and 112 represent any object in the online game, including game avatars, non-player characters, environmental objects, and the like.

The game program 125 is configured to instantiate or terminate game objects based on communications received via the wide-area network 150. Such communications indicate game activity from participants in the game. Thus, as new participants are added to a game session, the game program 125 instantiates new objects representing avatars for the new participants. As participants leave the game, the game program 125 can eliminate game objects representing avatars for the leaving participants. In addition, the game program 125 can change attributes of the game objects based on participants' interactions with objects in the game. For example, the game program 125 can change positional attributes of game objects based on a participant manipulating the objects with his avatar, or based on the position of the objects changing relative to the avatar.

To illustrate, in a particular embodiment the game object 110 is a sword. The game program 125 can receive communications indicating a participant's avatar has picked up the sword. In response, the game program 125 changes attributes of the game object 110 to indicate the sword is usable by the participant's avatar. As the sword is used by the avatar, the game program 125 can change the attributes of the game object 110 to represent aging of the sword or damage to the sword. These attribute changes can change the way the game object 110 interacts with other game objects. For example, as the sword ages, it may cause less damage to a non-player character in combat.

Based on the game objects, the game program 125 is configured to communicate data about the gaming environment via the wide area network 150 to the client devices 104 and 106. This allows participants at the client devices 104 and 106 to participate in a common game environment, so that one participant's interactions with the environment can affect the gaming experience of the other participant.

The game programs 120 and 122 are configured to provide a display of the gaming environment and an interface for a participant to interact with the environment. For ease of discussion, the configuration of the game program 120 will be described, but it will be appreciated that the game program 122 can be configured similarly.

The game program 120 sends communications via the wide area network 150 to the game server 102 indicating the position of an avatar associated with a participant of the game. To illustrate, the game program 120 provides an interface for a participant to enter (i.e. login to) the game. The participant enters authentication information, such as a password, and selects a particular avatar to represent the participant in the game environment. The game program 120 determines the position of the avatar in the game environment. When the participant first logs in, this position can be a predetermined initial position, a previously saved position, and the like. The game program 120 communicates the determined position to the game program 125 at the game server 102.

In response to receiving the positional data, the game program 125 determines which game objects are viewable or otherwise available for interaction by the participant's avatar. These game objects can include the avatars of the other participants. The game program 125 provides attribute information about the game objects to the game program 120 via the wide area network 150. The game program 125 can provide additional information, such as information about the participant's avatar (e.g. inventory information, health information, class information, and the like). Based on the received object information, the game program 120 provides a visual display representative of the game environment. In an embodiment, the game environment is displayed in a three-dimensional representation. As used herein, a three-dimensional representation refers to a representation that can be displayed on a two-dimensional display, but appears to be a three-dimensional object or environment. The game program 120 ensures that as an avatar moves through the game environment, the display of the environment is updated such that the environment appears three-dimensional. Accordingly, the game program 120 displays each game object so that the object appears three-dimensional in the game environment.

The game server 102 can also store a note object 115, which represents a note created by a participant in the game environment. To illustrate, a participant can create a note via the game program 120. As used herein, a note refers to information created by a game participant targeted for communication to one or more other participants, and can provide help, context, directions, humor, or comments to the other participants. The note can include text, graphical image information, animated image information, audio content, and the like. The game program 120 communicates the note content to the game program 125 via the wide area network 150. Based on the received note content, the game program 125 creates the note object 115. In an embodiment, the note object 115 is a special type of game object, and has modifiable attributes to indicate the objects position in the game environment as well as other characteristics.

Based on the note object 115, the game program 125 provides data to the game programs 120 and 122 to display the object. In an embodiment, the note object is displayed via the game programs 120 and 122 as a three-dimensional object in the game environment. Thus, participants in the game can enter notes, and have those notes displayed within the game environment. This provides for a more immersive experience for the game participants. For example, if the game environment is set in a fantasy milieu, the note objects can be displayed as three dimensional scrolls or signposts. If the game environment is a science fiction milieu, the note objects can be displayed via in-game computer screens or three-dimensional holograms.

The display of the note object 115 can be configured via the game program 120. For example, the participant entering the note can select a particular three-dimensional object that will display the note information. To illustrate, in a fantasy game environment, the participant can select whether the note is displayed via a scroll, a signpost, a special effect (e.g. three-dimensional text that appears to be on fire or frozen), and the like. Further, the game program 120 can allow the participant to determine a particular position for the note object 115. For example, the game program 120 can provide a drag-and-drop interface to allow the participant to determine the location for display of the note object 115. As the avatars of other game participants move in proximity to the object location, the game program 102 provides information about the object to the game programs associated with those avatars for display.

Further, the game program 120 can provide configuration options that determine to whom the note object 115 will be displayed. For example, the game program 120 can be configured the note object 115 so that it is only displayed to a subset of participants in the game environment. The subset can be based upon particular participant identification information (e.g. user IDs), participant groups (e.g. clans), character classes, and the like. In addition, the time that the note object 115 is displayed can be configurable. For example, the object can be configured so that it is changed or deleted based on the length of time it has been displayed, the number of times an avatar has interacted with the object, and the like.

Because the note object 115 can be a game object, it can be manipulated by avatars of game participants. The game program 120 can configure the note object 115 to set how it can be manipulated. For example, the note object 115 can be configured so that other participants can move the object, so that avatars can place the note object 115, or a copy thereof, in an inventory associated with the avatar, and the like.

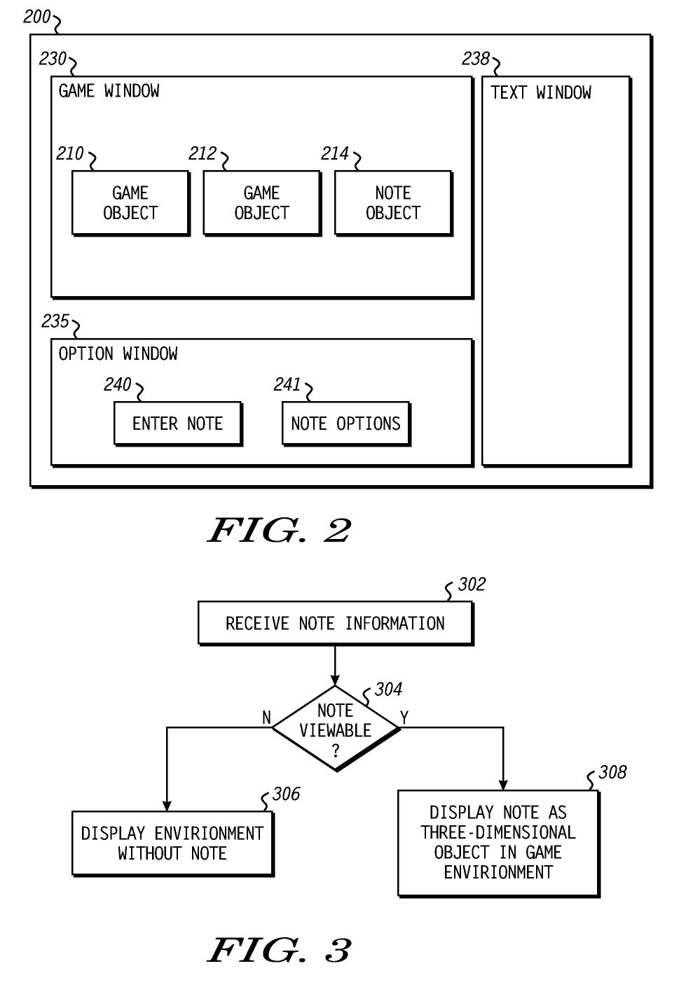

The game program 120 provides options via a graphical user interface to the game participant to configure note objects as described. This can be better understood with reference to FIG. 2. FIG. 2 illustrates a block diagram of a particular embodiment of a graphical user interface 200, which can be displayed based on information provided by the game program 120. The graphical user interface 200 includes a game window 230, an options window 235, and a text window 238.

The game window 230 displays the game environment based on information provided by the game program 125 at the game server 102. Thus the game window 230 displays game objects such as game object 210 and game object 212, representing objects, characters, and other aspects of the game environment. Each of these objects is displayed as three-dimensional objects, so that the game environment appears as a three-dimensional environment. Further, the game window 230 can display note objects such as note object 214. The note objects are displayed as three-dimensional objects within the game environment, just as other game objects.

The option window 235 provides a number of option buttons or menus, such as option button 240 and option button 241. The option buttons 240 and 241 can be selected by a game participant via a computer mouse or keyboard in order to access game options. In particular, selection of the option button 240 can cause creation of a note object, such as the note object 214, in the game window 230. In an embodiment, the contents of the game note can be based on text entered by the participant in the text window 238. In another embodiment, selection of the option button 240 can provide access to a menu including a number of predetermined message content items, such as pre-determined text strings or icons.

Selection of the option button 241 can provide access to options for a particular note. For example, a game participant can select a note object in the game window 230 and select the option button 241 to configure options for the selected note object. Alternatively, the option button 241 can be selected to configure options for a note to be subsequently placed in the game environment.

In response to selection of the option button 241, the graphical user interface 200 can provide a menu or other interface to provide for configuration of a note object. This can allow a participant to restrict to whom the note object is viewable, when and how often the note is viewable, note object fonts, colors, special effects, and the like. Further, the note object can be configured to display dynamic game information, such as whether the participant that created the note is currently participating in the game, a number of kills associated with the participant's avatar, health status of the avatar, location of the avatar in the game environment, and the like. Moreover, the note object can be configured to determine how the object can be manipulated by other participant's avatars. This degree of configuration allows note objects to be useful communication devices between game participants while maintaining the immersiveness of the game environment.

Referring to FIG. 3, a flow diagram of a method of displaying a three-dimensional note object in a game environment is illustrated. At block 302, information indicative of a note created by a network game participant is received. In an embodiment, the information is received at a client device executing a game program that communicates with a game server. The note can be created by a participant at a disparate client device executing its own version of the game program. Thus, notes can be created by one participant and displayed to other participants via the game environment.

At block 304, the game program at the client device determines whether the note indicated by the received information is viewable. This determination can be based on one or more of a variety of criteria, including the relative position of the note object in the game environment and the position of an avatar associated with the game program. Other criterion can include user identification information associated with an avatar of a game participant, group identification information associated with the avatar, character class information associated with the avatar, and the like.

If at block 304, it is determined that the note object is not viewable, at block 306 the game program displays the game environment without displaying the note object. Thus, if a game participant is not authorized to view the note object (e.g. because the participant's avatar is not part of a selected group), the participant will not be able to view the note, but can still interact in the game environment.

If, at block 304, it is determined that the note object is viewable, at block 308 the note object is displayed as a three-dimensional object in the game environment. Thus, the note can be displayed integrated with other game objects to preserve the character of the game experience.

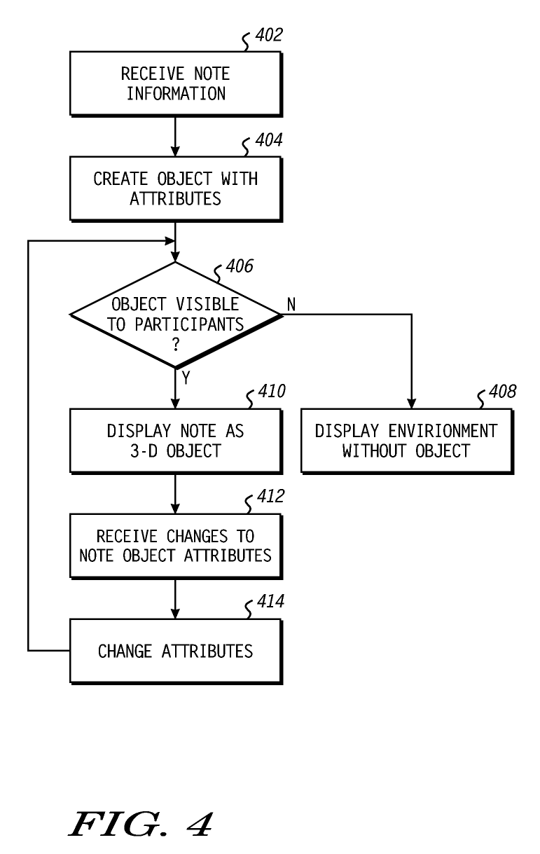

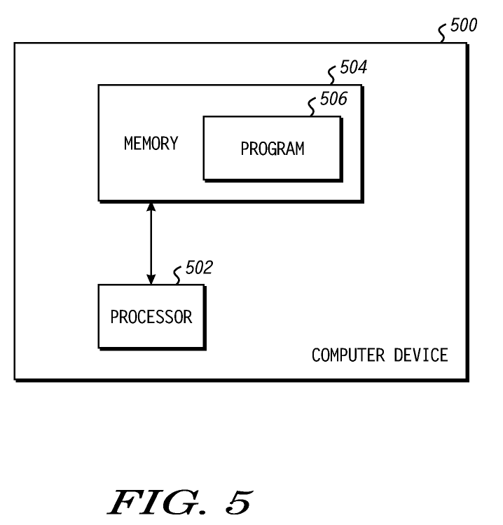

Referring to FIG. 4, a flow diagram of a particular embodiment of a method of creating a note object is illustrated. At block 402, note information is received at a game server from a first game program associated with a first participant in a networked game. The note information can be created at the first game program by the first participant, and will typically include text information entered by the participant. At block 404, a game program at the server creates a note object based on the received note information. The note object is created with attributes indicating the position of the object in the game environment, the type of object (e.g. the type of object that the note object will be displayed as in the game environment), text attributes such as font and size, and the like.

At block 406, the game program at the server determines whether the note object is visible to a participant in the network game, based on the position of the note object and on the position of an avatar associated with the participant. If the note object is not visible, at block 408 the game program at the server provides information to the game program associated with the participant so that the note object is not displayed. If the note object is visible, at block 410 the game server provides information indicative of the note object to the game program associated with the participant. The note object will be displayed as a three-dimensional object in the game environment. The information provided by the game server can be based on the object attribute information so that the note object is displayed as the proper object type, in the appropriate font, and the like.

At block 412, the game program at the game server receives information indicating a change to the note object attributes. This information can indicate a change in position of the note, a change in the object type to be displayed, a change in the text to be displayed with the note object, and the like. The change can be received from the game program associated with the original creator of the note object, or from a game program associated with a different participant. At block 414 the game program at the server changes the attribute information associated with the game object based on the received changes. The method flow returns to block 406 to update the object display for the game participants.

FIG. 5 shows a block diagram of a particular embodiment of a computer device 500. The computer device 500 can correspond to a client device or game server of FIG. 1, or both. The computer device 500 includes a processor 502 and a memory 504. The computer device 500 can include additional hardware, such as a network interface (not shown) to interface with the wide area network 150, a display device (not shown) to display the GUI 200 FIG. 2, and the like.

The memory 504 is a computer readable medium, and can be volatile memory, such as random access memory (RAM), or non-volatile memory, such as flash memory or a hard disk. The memory 504 stores a program 506 that includes instructions to manipulate the processor 502 in order to implement one or more of the methods described herein.

Other embodiments, uses, and advantages of the disclosure will be apparent to those skilled in the art from consideration of the specification and practice of the disclosure disclosed herein. The specification and drawings should be considered exemplary only, and the scope of the disclosure is accordingly intended to be limited only by the following claims and equivalents thereof.

What is claimed is:

1. A method comprising:
receiving first information indicative of a note created by a first participant of a networked game, the note including information targeted to a second participant of the networked game; and
displaying a first object as a three-dimensional object based on the first information, the first object displayed via a window configured to display a game environment of the networked game.

2. The method of claim 1, further comprising:
determining if the first object is viewable based on a first criterion; and
wherein displaying the first object comprises displaying the first object based on the first criterion.

3. The method of claim 2, wherein the first criterion is indicative of a position of an avatar associated with the second participant of the networked game.

4. The method of claim 2, wherein the first criterion is indicative of participant identification information associated with an avatar associated with the second participant of the networked game.

5. The method of claim 2, wherein the first criterion is indicative of group identification information associated with an avatar associated with the second participant of the networked game.

6. The method of claim 2, wherein the first criterion is indicative of character class information associated with an avatar associated with a second participant of the networked game.

7. The method of claim 1, wherein the first object indicates a position of an avatar associated with the first participant in the game environment.

8. The method of claim 1, wherein the first object indicates a status of an avatar associated with the first participant in the game environment.

9. The method of claim 1, wherein the first information indicates a first type of a plurality of object types, and wherein displaying the first object comprises displaying the text information with an object of the first type.

10. The method of claim 1, wherein the note includes information selected from the group consisting of: text information, graphical image information, animated image information, and audio information.

11. A method, comprising:
receiving first information from a first game program associated with a first participant, the first information indicative of a note including text information; and
creating a first note object in response to receiving the first information, the first note object configured for display as a three-dimensional object in a game environment.

12. The method of claim 12, further comprising communicating second information based on the first note object to a second game program associated with a second participant, the second information configured to display the first note object as a three-dimensional object at the second game program.

13. The method of claim 12, further comprising:
determining participant identification information associated with the second game program; and
wherein communicating second information comprises communicating the second information in response to determining the participant information.

14. The method of claim 11, further comprising changing attribute information associated with the first note object in response to a request.

15. The method of claim 14, further comprising receiving the request from the first game program.

16. The method of claim 14, further comprising receiving the request from a second game program.

17. The method of claim 14, wherein changing attribute information comprises changing position information to change a position of the note object in a game environment.

18. A computer readable medium comprising instructions to manipulate a processor, the instructions comprising instructions to:
receive first information indicative of a note created by a first participant of a networked game, the note including text information; and
display a first object as a three-dimensional object based on the first information, the first object displayed via a window configured to display a game environment of the networked game.

19. The computer readable medium of claim 18, wherein the instructions further comprise:
instructions to determine if the first object is viewable based on a first criterion; and
wherein the instructions to display the first object comprise instructions to display the first object based on the first criterion.

20. The method of claim 19, wherein the first criterion is indicative of a position of an avatar associated with a second participant of the networked game.
